(19) United States
(12) Patent Application Publication
(10) Pub. No.: US 2025/0250444 A1
(43) Pub. Date: Aug. 7, 2025

(54) COATING COMPOSITIONS AND METHODS OF APPLYING THE COMPOSITIONS TO COMPONENTS OF HVAC SYSTEM

(71) Applicant: Innovative HVAC Products LLC, West Palm Beach, FL (US)

(72) Inventors: Chad Armstrong, Boca Raton, FL (US); Stewart Kaiser, Palm Beach Gardens, FL (US)

(73) Assignee: Innovative HVAC Products LLC, West Palm Beach, FL (US)

(21) Appl. No.: 19/046,864

(22) Filed: Feb. 6, 2025

Related U.S. Application Data
(60) Provisional application No. 63/550,589, filed on Feb. 6, 2024.

(51) Int. Cl. C09D 5/14; C08K 3/105; C08K 3/34; C09D 5/10; C09D 163/00; F28F 19/04

(52) U.S. Cl. CPC C09D 5/14; C09D 5/10; C09D 163/00; F28F 19/04; C08K 3/105; C08K 3/34; C08K 2201/001; C08K 2201/005

(57) ABSTRACT

A coating composition that includes an uncured epoxy and at least one of an antimicrobial agent or a thermally conductive agent dispersed therein. Heat transfer components coated with the coating composition are also provided, as are methods of applying the coating composition to such heat transfer components.

### CROSS-REFERENCES TO RELATED APPLICATIONS

This application claims priority under 35 U.S.C. § 119(e) to U.S. Provisional Application No. 63/550,589, filed on Feb. 6, 2024, the entire contents of which are incorporated herein by reference.

### FIELD

This disclosure relates generally to coating compositions for heating, ventilation, and air conditioning (HVAC) systems, and more particularly to coating compositions with antimicrobial and anticorrosive properties, coating compositions with improved thermal absorption and heat transfer properties, and methods of applying the coating compositions to one or more components of HVAC systems.

### BACKGROUND

Heat transfer equipment, such as the coils of an air conditioning system, are frequently exposed to extreme conditions. In order to have useful lifetimes, materials are selected to produce durable and functional components.

### SUMMARY

In one aspect, a coating composition is provided that includes an uncured epoxy and at least one of an antimicrobial agent or a thermally conductive agent dispersed therein. In some embodiments, the antimicrobial agent comprises metal particles. In some embodiments, the thermally conductive agent comprises a zeolite.

In another aspect, an air conditioning coil is provided that includes a plurality of fins that are covered with an epoxy coating. The epoxy coating comprises a cured epoxy phase with at least one of an antimicrobial agent or a thermally conductive agent embedded therein.

In yet another aspect, a method of improving the performance of an air conditioning coil is provided. The method can include applying a coating composition as described herein onto an air conditioning coil.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, explain the principles and operations of the claimed subject matter.

### DETAILED DESCRIPTION

Reference will now be made in detail to the exemplary embodiment(s), examples of which is/are illustrated in the examples. The specific details of the various embodiments described herein are used for demonstration purposes only, and no unnecessary limitation or inferences are to be understood therefrom. Before describing the exemplary embodiments, it is noted the embodiments reside primarily in combinations of components, subcomponents, and procedures related to the coating compositions and methods of applying the coating compositions to one or more components of HVAC systems. Accordingly, the product and method components have been represented where appropriate, showing only those specific details that are pertinent to understanding the embodiments of the present disclosure so as not to obscure the disclosure with details that will be readily apparent to those of ordinary skill in the art having the benefit of the description herein.

In various embodiments, a coating composition is provided. In some embodiments, the coating composition is configured for application to one or more components of an HVAC system. In some embodiments, the coating composition is applied to an evaporator coil. The evaporator coil is located inside an indoor unit of the HVAC system and contains a network of tubes, typically made from copper or aluminum, that are responsible for absorbing heat from indoor air. During use, refrigerant is circulated through the network of tubes in the evaporator coil and the refrigerant is converted from a liquid to a gas as it absorbs heat from the air.

In some embodiments, the coating composition is applied to a condenser coil. The condenser coil is located inside an outside unit of the HVAC system and contains a network of tubes that are responsible for releasing the absorbed heat to the outside air. During use, the hot refrigerant from the evaporator coil passes through the condenser coil, which causes it to release the heat to the environment and convert the refrigerant back into a liquid. The liquid refrigerant is then circulated back to the evaporator coil to repeat the cooling cycle. In some embodiments, the coating composition is applied to the evaporator coil, the condenser coil, or both.

The coating composition comprises a plurality of components, including, for example, two or more components, three or more components, four or more components, etc. In some embodiments, for example, the coating composition comprises a carrier and one or more antimicrobial agents. In some embodiments, the coating composition comprises a carrier and one or more thermally conductive agents. In some embodiments, the coating composition comprises a carrier, one or more antimicrobial agents, and one or more thermally conductive agents.

In some embodiments, the carrier is an epoxy. Epoxy resins, or polyepoxides, are polymers or polymerizable chemicals having an epoxide in their chemical structure. Epoxy resins can be applied to a substrate that, after curing, form a waterproof coating. In some embodiments, the carrier will impart anti-corrosive properties to the substrate. For example, evaporator coils and condenser coils are exposed to various levels of moisture and/or coastal air containing various levels of salt or other particles. In some embodiments, an epoxy-based composition can coat the exposed surfaces of the treated substrate and form a barrier that prevents the moisture or other particles from affixing to the surface of the underlying copper and aluminum evaporator coils and condenser coils. An epoxy-based coating composition can impart thermal resistance to the underlying copper and aluminum evaporator coils and condenser coils.

In some embodiments, the coating composition comprises an uncured epoxy and at least one of an antimicrobial agent or a thermally conductive agent dispersed therein. In some embodiments, the coating composition comprises an uncured epoxy and an antimicrobial agent dispersed therein. In some embodiments, the coating composition comprises an uncured epoxy and a thermally conductive agent dispersed therein. In some embodiments, the coating composition comprises an uncured epoxy with an antimicrobial agent or a thermally conductive agent dispersed therein.

In some embodiments, the uncured epoxy can be any epoxy known to those of skill in the art. As will be understood, uncured epoxy generally includes a stable resin and a hardener, which when combined produce a cured epoxy.

In some embodiments, the resin used can be selected from, but not limited to, rosin, bisphenol-A diglycidyl ether (DGEBA), novolac epoxy resins, aliphatic epoxy resins, glycidylamine epoxy resins, and hydrogenated bisphenol-A epoxy resins. In some embodiments, the resin used is rosin.

In some embodiments, the hardener used can be selected from, but are not limited to, copper(I) oxide, aromatic amines, aliphatic amines, cycloalipathic amines (rosin acylamino amine), novolacs, anhydrides, polyamides, and polyamido-amines, and polymercaptans (thiols). In some embodiments, the hardener is copper(I) oxide.

In some embodiments, comprising a solvent system. In some embodiments, the solvent system comprises organic solvents or thinners. In some embodiments, the organic solvents can be selected from xylene mixtures (m-xylene, o-xylene, p-xylene), ethylbenzene, and other volatile organic solvents.

In some embodiments, the uncured epoxy comprises 40 to 70 parts hardener and 5 to 10 parts rosen. In some embodiments, the hardener is copper(I) oxide.

In some embodiments, the coating composition can include plasticizers and other additives. Butyl benzyl phthalate is an example of a plasticizer useful herein.

In some embodiments, the antimicrobial agent comprises metal particles.

In some embodiments, the metal particles comprise a metal selected from the group consisting of copper, aluminum, zinc, selenium, gold, nickel, gallium, mercury, bismuth, cobalt, zirconium, molybdenum, lead, and arsenic. In some embodiments, the metal particles comprise a metal selected from copper, aluminum, and zinc.

In some embodiments, the metal particles comprise two metals selected from the group consisting of copper, aluminum, zinc, selenium, gold, nickel, gallium, mercury, bismuth, cobalt, zirconium, molybdenum, lead, and arsenic. In some embodiments, the metal particles comprise two metals selected from copper, aluminum, and zinc.

In some embodiments, the metal particles have a mean particle size in the range from 10 to 100 microns. In some embodiments, the metal particles have a mean particle size ranging from 15 to 80 μm, or 20 to 70 μm, or 30 to 50 μm.

In some embodiments, a weight ratio of the antimicrobial agent to the uncured epoxy resin ranges from 0.5:1 to 4:1. In some embodiments, a weight ratio of the antimicrobial agent to the uncured epoxy resin is at least 0.6:1 or at least 0.75:1, or at least 1:1. In some embodiments, a weight ratio of the antimicrobial agent to the uncured epoxy resin is up to 3.5:1, or up to 3:1, or us to 2:1.

In some embodiments, the thermally conductive agent comprises a material such as zeolite.

In some embodiments, a mean mean particle size of the thermally conductive agent ranges from 10 to 100 microns. In some embodiments, the metal particles have a mean particle size ranging from 15 to 80 μm, or 20 to 70 μm, or 30 to 50 μm.

In various embodiments, for example, the epoxy composition comprises copper(I) oxide in an amount ranging from 40-70%, rosin in an amount ranging from 5-10%, xylenes (mixture of ortho-, meta-, and para-isomers) in an amount ranging from 3-7%, ethylbenzene in an amount ranging from 1-5%, m-xylene in an amount ranging from 1-5%, o-xylene in an amount ranging from 1-5%, butyl benzyl phthalate in an amount ranging from 0.5-1.5%, and p-xylenes in an amount ranging from 0.1-1%. All percentages are based on weight of the epoxy composition.

In some embodiments, the coating composition includes one or more antimicrobial agents. In this context, the term antimicrobial refers to an ability to reduce or prevent the growth of bacteria (e.g., zooglea), fungi (e.g., mold), and/or other microbes.

In some embodiments, the antimicrobial agent is copper (e.g., elemental copper). In some embodiments, the antimicrobial agent is silver (e.g., elemental silver). In such embodiments, the copper and/or silver are in the form of a solid particle or powder. In some embodiments, the copper and/or silver are particles having a size in a range from 10 to 100 microns (μm), including any subranges thereof (e.g., 15-80 μm; 20-70 μm; 30-50 μm). Copper and silver particles can disrupt the growth of bacteria. In various embodiments, for example, the epoxy composition comprises each respective antimicrobial agent in an amount ranging from 50 cubic centimeters (cc) to 5000 cc per 1000 cc of epoxy. In some embodiments, the antimicrobial agent is provided in an amount relative to the epoxy carrier in a ratio ranging from about 0.5:1 to about 4:1, including any subranges thereof (e.g., 0.6:1, 2:1, 2.5:1, etc.).

In some embodiments, the coating composition includes one or more thermally conductive agents. In this context, the term thermally conductive agent refers to the ability of the component to improve the thermal absorption ability and/or heat transfer capabilities compared to the carrier component (e.g., the epoxy). In some embodiments, for example, the thermally conductive agent is a zeolite. Zeolite is a porous material primarily comprising silicon, aluminum, and oxygen. Zeolite has unique thermal conductive properties and can absorb four times more thermal energy than water. In such embodiments, the zeolite is in the form of a solid particles or powder. In some embodiments, the zeolite is in the form of particles having a mean size in the range from 10 to 100 microns (μm), including any subranges thereof (e.g., 15-80 μm; 20-70 μm; 30-50 μm).

In some embodiments, the zeolite is added to the epoxy-based coating composition, which is applied to components of a heat transfer device (e.g., evaporator coils, condensor coils, additional air conditioning piping, etc.). In such embodiments, the zeolite increases the rate at which heat can be absorbed and transferred to the underlying evaporator coils (e.g., copper and aluminum), and ultimately absorbed by the refrigerant contained therein. In such embodiments, the zeolite facilitates the transfer of thermal energy (heat) to a material having less thermal energy. In some embodiments, for example, as warm air moves across an evaporator coil, the epoxy-based coating with zeolite embedded therein will absorb heat from the air and transfer the heat to the cold refrigerant more effectively than an epoxy-based coating composition alone or an epoxy-based coating composition comprising only copper and aluminum particles. Alternatively, when the HVAC system is used to heat a structure, the heat generated by the HVAC system is more readily transferred to the cold air stream.

In some embodiments, zeolite is added to the epoxy-based coating composition, which is applied to the condenser coils. In such embodiments, the zeolite increases the efficiency in which heat can be removed from the hot refrigerant through the copper and aluminum coils and ultimately released into the outdoor air forced through the unit by a fan. In some embodiments, the zeolite embedded in the epoxy-based coating composition expedites the transfer of heat by absorbing and releasing the thermal energy more effectively than an epoxy-based coating composition alone or an epoxy-based coating composition comprising only copper and aluminum particles.

In some aspects, an air conditioning coil having a plurality of fins covered with an epoxy coating is provided. The epoxy coating includes a cured epoxy phase with at least one of an antimicrobial agent or a thermally conductive agent embedded therein. The epoxy coating can be formed and/or applied using the coating composition described herein.

In some embodiments, the antimicrobial agent comprises metal particles. In some embodiments, the metal particles have a mean particle size in the range from 10 to 100 microns. In some embodiments, a weight ratio of the antimicrobial agent to the cured epoxy resin ranges from 0.5:1 to 4:1.

In some embodiments, a mean particle size of the thermally conductive agent ranges from 10 to 100 microns.

In some embodiments, a thickness of the epoxy coating is in a range from 1 to 20 mm.

In various embodiments, a method of applying the coating composition to a component of an HVAC system is provided. In some such embodiments, the hardener and the resin can be combined shortly before applying the coating composition to the target substrate (e.g., evaporator coil, condenser coil, a pipe, etc.)

Epoxy-based coating compositions can be applied in various ways. In some embodiments, for example, the epoxy-based coating composition is sprayed on to the HVAC component. The spraying method has the advantage of transportability, which means the coating can be delivered to a work site with an existing HVAC system installed thereon (e.g., a residential or commercial property). In such embodiments, a component can be removed from a HVAC system and sprayed with the coating composition at the work site. After treatment, the component can be dried in open air before reassembling the HVAC system.

In some embodiments, for example, the substrate is immersed in a bath containing the epoxy-based coating composition. The dipping method has the advantage of assuring complete coverage of the component with the coating. This method is generally limited to the components of HVAC systems prior to their installation (e.g., a residential or commercial property). After treatment, the substrate can be dried in open air or baked to cure the coating.

In some embodiments, the coating composition is applied to one or more components of an HVAC system, including, for example, the evaporator coils and/or condenser coils. In some embodiments, the coating composition imparts anticorrosive properties to the one or more HVAC components. In some embodiments, the coating composition imparts antimicrobial properties to the one or more HVAC components. In some embodiments, the coating composition improves the thermal absorption and heat transfer properties of the evaporator coils and condenser coils.

In some embodiments, the coating composition is applied to the component to obtain a coating having a thickness in a range of about 1 mm to about 20 mm, or about 2 mm to about 15 mm, or about 3 mm to about 13 mm, etc. Generally, as one of skill in the art would appreciate, thermal conductivity is inversely proportional to the thickness of the applied coating, so a thicker coating will generally cause a loss of heat transfer capability. In some embodiments, the coating thickness is thick enough to prevent corrosion and/or microbial growth on the underlying component. In some embodiments, the coating thickness is thin enough to reduce or minimize the loss of thermal conductivity. In some embodiments, the application time for applying the coating to the component is adjusted to obtain a desired thickness.

In various embodiments, a method of making the coating composition is provided. The method can include a plurality of steps. For example, the method can include a step of adding the carrier to a reaction vessel, a step of adding one or more antimicrobial agents to the reaction vessel, and a step of adding one or more thermally conductive agents to the reaction vessel. In some embodiments, the steps are carried out sequentially. In some embodiments, the steps are carried out simultaneously. In some embodiments, one or more of the steps are omitted. In some embodiments, one or more of the steps are followed by a step of mixing the components. In such embodiments, the mixing step can be carried out for a period in a range of about 1 minute to about 120 minutes, or about 5 minutes to about 60 minutes, or any subrange thereof. In various embodiments, the steps of the method are carried out at a temperature in the range of about 20° C. to 75° C., or about 20° C. to 50° C., or about 20°° C. to 40° C., including any subranges thereof.

### EXAMPLES

Example 1. Preparation of the coating composition. To a reaction vessel maintained at room temperature (˜22° C.) was added 946 cc of epoxy polymer (40-70% copper(I) oxide; 5-10% rosin; 3-7% xylenes (mixture of isomers); 1-5% ethylbenzene; 1-5% m-xylene; 1-5% o-xylene; 0.5-1.5% butyl benzyl phthalate; 0.1-1% p-xylenes). Next, 1892 cc of copper powder, 189 cc of silver powder, and 757 cc of zeolite powder were added to the reaction vessel containing the epoxy polymer. The resulting mixture of was stirred for about 10 minutes at room temperature. The obtained coating composition contained 50% copper, 20% zeolite, 5% silver, 10% rosin, 7% xylenes, 3% ethylbenzene, and 5% butyl benzyl phthalate.

Example 2. Application of the coating composition to an evaporator coil. An evaporator coil made from copper and aluminum was added to the reaction vessel in Example 1 and submerged to coat all surfaces of the coil. The coil was then allowed to air dry over several hours.

Example 3. Testing thermal conductivity. The coil from Example 2 was installed in a HVAC unit and compared with an equivalent uncoated coil.

A 3-ton evaporator coil was installed inside a R-15 square of duct board with capped ends, a 800 cfm furnace fan blower was installed on one side of the duct, and an 8-inch round damper was installed on the opposite end of the duct. The coil was supplied with hot water at 150° F. and discharged into a sink. The temperature of the hot water was measured at the coil inlet and also at the coil outlet to determine the temperature difference.

For the uncoated coil, the temperature differences for three tests were as follows:
Test 1: 18° F. Delta
Test 2: 17.2° F. Delta
Test 3: 18.1° F. Delta
Average Delta: 17.7° F.

Three tests were also conducted with a coil coated with 1-3 mm of the coating composition described in Examiner 1, and the results were as follows:
Test 1: 20.2° F. Delta
Test 2: 21.1° F. Delta
Test 3: 22.1° F. Delta
Average Delta: 21.1° F.

Thus, the coated coil increased the temperature drop by 19%, which resulted in an efficiency increase of 10-16%.

The foregoing embodiments are provided to aid in the understanding of the present disclosure, the true scope of which is set forth in the appended claims. One of skill in the art would appreciate that modifications can be made in the embodiments set forth without departing from the spirit of the disclosure.

Example 4. Corrosion Testing. Two coils including both copper and aluminum were sprayed with salt water for 1 hour each day for 60 days. One coil was untreated, while the other coil was treated with the coating composition of Example 1 to produce a coating 1-3 mm thick. At the end of the 60 days, the uncoated coil showed high levels of oxidation on the copper and corrosion on the aluminum, while the coated coil showed no visible signs of corrosion or oxidation.

Exemplary embodiments and examples of the compositions and methods are described above in detail. The compositions and/or methods are not limited to the specific embodiments described herein, but rather, components of the compositions and/or steps of the method may be utilized independently and separately from other components and/or steps described herein. For example, the compositions may also be used in combination with other compositions and/or methods and are not limited to practice with only an HVAC component as described herein. Rather, the exemplary embodiment can be implemented and utilized in connection with many other systems.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context.

As used herein, the use of examples, or exemplary language (e.g., “such as”), is intended to illuminate the embodiments and does not pose a limitation on the scope of the claims unless otherwise stated. No language in the specification should be construed as indicating any non-claimed element as essential.

As used herein, the terms “about” and “substantially” will be understood by persons of ordinary skill in the art and will vary to some extent depending upon the context in which it is used. If there are uses of the term which are not clear to persons of ordinary skill in the art, given the context in which it is used, “about” and “substantially” will mean up to plus or minus 10% of the particular term.

This written description uses examples to disclose the present embodiments, including the best mode, and to enable any person skilled in the art to practice the present embodiments, including carrying out the steps of the method. The patentable scope of the present embodiments is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

What is claimed is:

1. A coating composition, comprising an uncured epoxy and at least one of an antimicrobial agent or a thermally conductive agent dispersed therein.

2. The coating composition of claim 1, further comprising a solvent system.

3. The coating composition of claim 1, wherein the antimicrobial agent comprises metal particles.

4. The coating composition of claim 3, wherein the metal particles comprise a metal selected from the group consisting of copper, aluminum, zinc, selenium, gold, nickel, gallium, mercury, bismuth, cobalt, zirconium, molybdenum, lead, and arsenic.

5. The coating composition of claim 3, wherein the metal particles have a mean particle size in the range from 10 to 100 microns.

6. The coating composition of claim 1, wherein a weight ratio of the antimicrobial agent to the uncured epoxy resin ranges from 0.5:1 to 4:1.

7. The coating composition of claim 1, wherein the thermally conductive agent comprises zeolite.

8. The coating composition of claim 7, wherein a mean particle size of the thermally conductive agent ranges from 10 to 100 microns.

9. The coating composition of claim 1, wherein the uncured epoxy comprises 40 to 70 parts hardener and 5 to 10 parts rosen.

10. An air conditioning coil, comprising a plurality of fins, wherein said fins are covered with an epoxy coating, wherein the epoxy coating comprises a cured epoxy phase with at least one of an antimicrobial agent or a thermally conductive agent embedded therein.

11. The air conditioning coil of claim 10, wherein the antimicrobial agent comprises metal particles.

12. The air conditioning coil of claim 11, wherein the metal particles have a particle size in the range from 10 to 100 microns.

13. The air conditioning coil of claim 10, wherein a weight ratio of the antimicrobial agent to the epoxy resin ranges from 0.5:1 to 4:1.

14. The air conditioning coil of claim 10, wherein a particle size of the thermally conductive agent ranges from 10 to 100 microns.

15. The air conditioning coil of claim 10, wherein a thickness of the epoxy coating is in a range from 1 to 20 mm.

16. A method of improving the durability and of an air conditioning coil, comprising applying a coating composition of claim 1 to an air conditioning coil.
